(19) United States
(12) Patent Application Publication
(10) Pub. No.: US 2015/0195469 A1
(43) Pub. Date: Jul. 9, 2015

(54) IMAGE SENSOR AND IMAGE PROCESSING SYSTEM INCLUDING THE SAME

(71) Applicant: SAMSUNG ELECTRONICS CO., LTD., SUWON-SI (KR)

(72) Inventor: MIN HO KIM, SEONGNAM-SI (KR)

(21) Appl. No.: 14/556,106

(22) Filed: Nov. 29, 2014

(30) Foreign Application Priority Data
Jan. 3, 2014 (KR) 10-2014-000724

(51) Int. Cl. H04N 5/374; H04N 5/378

(52) U.S. Cl. CPC H04N 5/374; H04N 5/378

(57) ABSTRACT

An image sensor includes a pixel array and a plurality of micro lenses. The pixel array includes a plurality of pixel groups, and each of the plurality of pixel groups includes a plurality of binary pixels. Each of the plurality of micro lenses is formed below a respective pixel group and has an area corresponding to the respective pixel group.

### CROSS-REFERENCE TO RELATED APPLICATIONS

A claim of priority under 35 U.S.C. §119(a) is made to Korean Patent Application No. 10-2014-0000724 filed on Jan. 3, 2014, the disclosure of which is hereby incorporated by reference in its entirety.

### BACKGROUND

Embodiments of the present disclosure relate to an image sensor and an image processing system including the same, and more particularly, to an image sensor capable of maintaining sensitivity under a particular light condition and an image processing system including the same.

An image sensor is a device that converts an optical image into an electrical signal. The image sensor includes a plurality of pixels, each of which includes a number of transistors. For example, a pixel that includes a transfer transistor, a reset transistor, a selection transistor, and a source follower transistor, may be referred to as a 4T pixel.

Technology developments have lead to reductions in pixel size. For instance, 1T pixels, i.e., pixels having a single-transistor structure have been developed to use instead of 4T pixels to reduce pixel size.

### SUMMARY

According to some embodiments of the present disclosure, there is provided an image sensor including a pixel array and a plurality of micro lenses. The pixel array includes a plurality of pixel groups, and each of the plurality of pixel groups includes a plurality of binary pixels. Each of the plurality of micro lenses is formed below a respective pixel group and has an area corresponding to the respective pixel group.

The image sensor may further include a plurality of sub micro lenses, and each sub micro lens is formed between the corresponding micro lens and the corresponding pixel group.

The plurality of sub micro lenses may have a greater refractive index than the plurality of micro lenses.

Each pixel group may include a first binary pixel group close to a center of the pixel group and a second binary pixel group close to an edge of the pixel group. A photodiode of each of binary pixels included in the first binary pixel group may have a greater integration capacity than a photodiode of each of binary pixels included in the second binary pixel group.

The photodiode of each binary pixel included in the first binary pixel group may be formed deeper than the photodiode of each binary pixel included in the second binary pixel group.

The photodiode of each binary pixel included in the first binary pixel group may be formed larger than the photodiode of each binary pixel included in the second binary pixel group.

The image sensor may further include a readout block configured to process a pixel signal output from each of columns in the pixel array, a row driver block configured to control an operation of the pixel array, and a timing controller configured to control the readout block and the row driver block.

The image sensor may further include an image signal processor configured to pixelize the pixel signal by applying a weight to the pixel signal and generate image data based on the pixelized pixel signal.

According to other embodiments of the present disclosure, there is provided an image sensor including a pixel array and a plurality of micro lenses. The pixel array includes a plurality of pixel groups, and each of the plurality of pixel groups includes a plurality of binary pixels. Each of the plurality of micro lenses is formed below a respective pixel group and has an area corresponding to the respective pixel group. Here, each pixel group may include a first binary pixel group close to a center of the pixel group and a second binary pixel group close to an edge of the pixel group. A photodiode of each of binary pixels included in the first binary pixel group may have a greater integration capacity than a photodiode of each of binary pixels included in the second binary pixel group.

The image sensor may further include a plurality of sub micro lenses, and each sub micro lens is formed between the corresponding micro lens and the corresponding pixel group.

The plurality of sub micro lenses may have a greater refractive index than the plurality of micro lenses.

The photodiode of each binary pixel included in the first binary pixel group may be formed deeper than the photodiode of each binary pixel included in the second binary pixel group.

The photodiode of each binary pixel included in the first binary pixel group may be formed larger than the photodiode of each binary pixel included in the second binary pixel group.

The image sensor may further include a readout block configured to process a pixel signal output from each of columns in the pixel array, a row driver block configured to control an operation of the pixel array, and a timing controller configured to control the readout block and the row driver block.

According to further embodiments of the present disclosure, there is provided an image processing system including an image sensor configured to generate a pixel signal according to an intensity of incident light and an image signal processor configured to pixelize the pixel signal by applying a weight to the pixel signal and generate image data based on the pixelized pixel signal. The image sensor includes a pixel array, a plurality of micro lenses, a readout block configured to process the pixel signal that is output from each of columns in the pixel array, a row driver block configured to control an operation of the pixel array, and a timing controller configured to control the readout block and the row driver block. The pixel array includes a plurality of pixel groups, and each of the plurality of pixel groups includes a plurality of binary pixels. Each of the plurality of micro lenses is formed below a respective pixel group and has an area corresponding to the respective pixel group.

The image sensor may further include a plurality of sub micro lenses. Each sub micro lens is formed between the corresponding micro lens and the corresponding pixel group.

The plurality of sub micro lenses may have a greater refractive index than the plurality of micro lenses.

Each pixel group may include a first binary pixel group close to a center of the pixel group and a second binary pixel group close to an edge of the pixel group. A photodiode of each of binary pixels included in the first binary pixel group may have a greater integration capacity than a photodiode of each of binary pixels included in the second binary pixel group.

The photodiode of each binary pixel included in the first binary pixel group may be formed deeper than the photodiode of each binary pixel included in the second binary pixel group.

The photodiode of each binary pixel included in the first binary pixel group may be formed larger than the photodiode of each binary pixel included in the second binary pixel group.

### BRIEF DESCRIPTION OF THE DRAWINGS

The above and other features and advantages of the present disclosure will become readily apparent from the detailed description that follows, with reference to the attached drawings in which:

FIG. 1 is a block diagram of an image processing system according to some embodiments of the present disclosure;

FIG. 2 is a detailed block diagram of an example of a binary pixel in a pixel array illustrated in FIG. 1;

FIG. 3 is a diagram of a layout example for forming the binary pixel illustrated in FIG. 2;

FIG. 4 is a diagram of a cross section of a semiconductor substrate taken along an A direction in the layout illustrated in FIG. 3 according to some embodiments of the present disclosure;

FIG. 5 is a diagram of a cross section of a semiconductor substrate taken along the A direction in the layout illustrated in FIG. 3 according to other embodiments of the present disclosure;

FIG. 6 is a diagram of a cross section of a semiconductor substrate taken along the A direction in the layout illustrated in FIG. 3 according to further embodiments of the present disclosure;

FIG. 7 is a diagram of an example of a part of the pixel array illustrated in FIG. 1;

FIG. 8A is a diagram of a cross section of the partial pixel array illustrated in FIG. 7, taken along a B direction, according to some embodiments of the present disclosure;

FIG. 8B is a diagram of a cross section of the partial pixel array illustrated in FIG. 7, taken along the B direction, according to other embodiments of the present disclosure;

FIG. 9A is a diagram of a cross section of the partial pixel array illustrated in FIG. 7, taken along the B direction, according to further embodiments of the present disclosure;

FIG. 9B is a diagram of a cross section of the partial pixel array illustrated in FIG. 7, taken along the B direction, according to other embodiments of the present disclosure;

FIG. 10 is a diagram of a cross section of the partial pixel array illustrated in FIG. 7, taken along the B direction, according to still other embodiments of the present disclosure;

FIG. 11 is a diagram of another example of the part of the pixel array illustrated in FIG. 1;

FIG. 12 is a flowchart of an example method of forming a photodiode for each of binary pixels illustrated in FIG. 10;

FIG. 13 is a flowchart of an example method of forming a photodiode for each of binary pixels illustrated in FIG. 11;

FIG. 14 is a block diagram of an electronic system including an image sensor illustrated in FIG. 1 according to some embodiments of the present disclosure; and

FIG. 15 is a block diagram of an electronic system including an image sensor illustrated in FIG. 1 according to other embodiments of the present disclosure.

### DETAILED DESCRIPTION OF THE EMBODIMENTS

The present disclosure now will be described more fully hereinafter with reference to the accompanying drawings, in which embodiments of the inventive concepts are shown. The inventive concepts may, however, be embodied in many different forms and should not be construed as limited to the embodiments set forth herein. Rather, these embodiments are provided so that this disclosure will be thorough and complete, and will fully convey the scope of the present disclosure to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

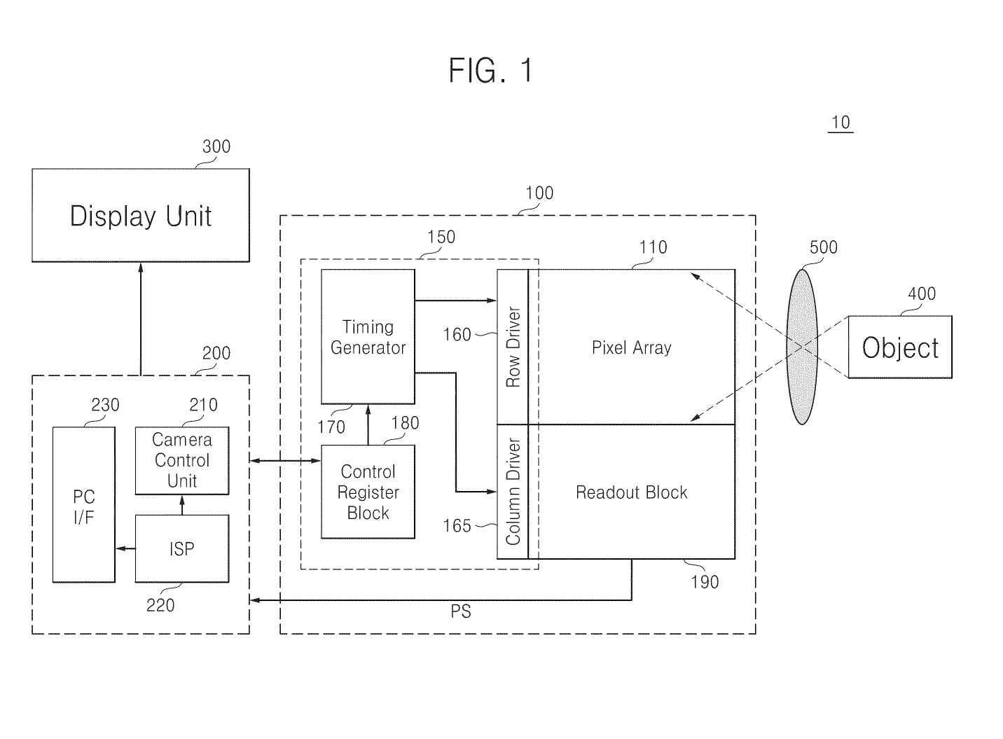

FIG. 1 is a block diagram of an image processing system 10 according to some embodiments of the present disclosure. The image processing system 10 may include the image sensor 100, a digital signal processor (DSP) 200, a display unit 300, and a lens 500. The image sensor 100 may include a pixel array 110, a control unit 150, and a readout block 190.

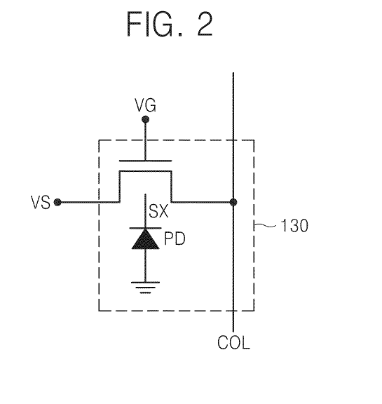

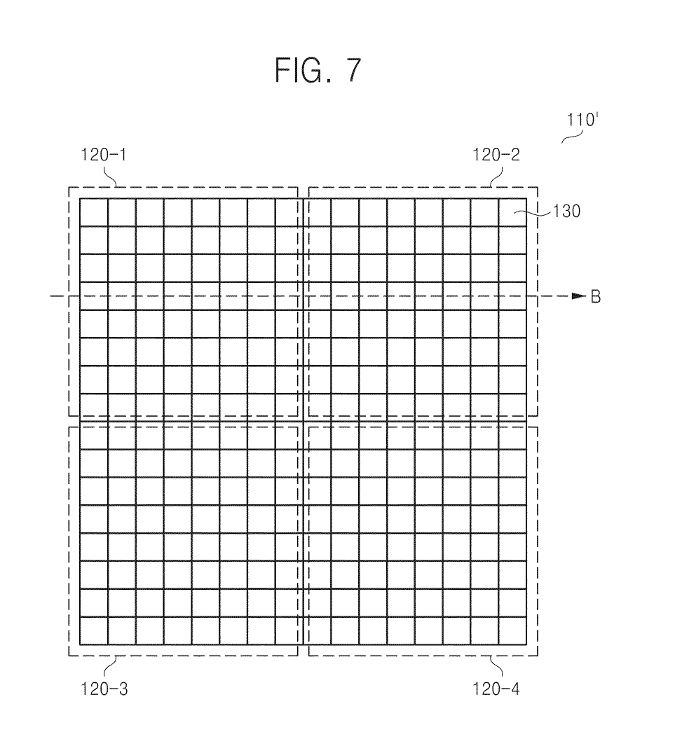

The pixel array 110 may include a plurality of binary pixels (i.e., 130 in FIG. 2). Each of the plurality of binary pixels 130 detects at least one photocharge and generates a digital binary pixel signal. The plurality of binary pixels 130 are divided into a plurality of pixel groups (first through fourth pixel groups 120-1 through 120-4 in FIG. 7). Each of the plurality of pixel groups (first through fourth pixel groups 120-1 through 120-4 in FIG. 7) includes binary pixels 130 that correspond to a single pixel. Each of the plurality of binary pixels 130 includes a single transistor (SX in FIG. 2) and a photoelectric conversion element (e.g., PD in FIG. 2). The photoelectric conversion element is a photodiode or a pinned photodiode.

Each binary pixel 130 includes only single transistor, thereby increasing the degree of integration of the image sensor 100. For instance, the image sensor 100 may include the binary pixels 130 having a size of 0.1×0.1 μm or less. The pixel array 110 senses light using a plurality of photoelectric conversion elements, and converts the light into electrical signals to generate binary pixel signals. The operation of the binary pixels 130 will be described in detail with reference to FIG. 7 later.

The control unit 150 may generate and provide a plurality of control signals for controlling the operations of the pixel array 110 and the readout block 190. The control unit 150 may include a row driver 160, a column driver 165, a timing generator 170, and a control register block 180.

The row driver 160 drives the pixel array 110 in row units. In other words, pixels in one row may be provided with the same control signals, i.e., a gate signal (e.g., VG in FIG. 2) and a source signal (VS in FIG. 2). In other words, the row driver 160 may decode a control signal that is output from the timing generator 170 and provide the control signal for each row of the pixel array 110.

The pixel array 110 outputs a binary pixel signal from a row selected by the gate signal (VG in FIG. 2) and the source signal (VS in FIG. 2) provided from the row driver 160 to the readout block 190.

The column driver 165 may generate a plurality of control signals according to the control of the timing generator 170 and may control the operation of the readout block 190.

The timing generator 170 may apply a control signal or a clock signal to the row driver 160 and the column driver 165 to control the operations or timing of the row driver 160 and the column driver 165. The timing generator 170 may generate the control signal or the clock signal to be applied to the row driver 160 and the column driver 165 using a control signal and a clock signal provided from the control register block 180. At this time, the control register block 180 operates according to the control of a camera control unit 210, and the control register block 180 may store or buffer the control signal and the clock signal.

The readout block 190 may generate a digital pixel signal PS based on a result of comparing a binary pixel signal generated by each of the binary pixels 130 with a reference voltage, and output the digital pixel signal PS to the DSP 200. The readout block 190 may include a comparator (not shown) that compares binary pixel signals received by columns with the reference voltage, a counter (not shown) that counts a comparison result of the comparator, and a memory (not shown) that stores a count result of the counter.

The DSP 200 may generate image data by processing the pixel signal PS that is output from the image sensor 100, and output the image data to the display unit 300. The DSP 200 may include the camera control unit 210, an image signal processor (ISP) 220, and a personal computer interface (PC I/F) 230.

The camera control unit 210 controls the control register block 180. The camera control unit 210 may control the control register block 180 using an inter-integrated circuit (I²C), but the scope of the present disclosure is not restricted thereto.

The ISP 220 processes the pixel signal PS that is output from the readout block 190 into image data that are nice for people to look at, and the ISP 220 outputs the image data to the display unit 300 through the PC I/F 230. The ISP 220 is implemented in a chip separated from the image sensor 100. Alternatively, the ISP 220 and the image sensor 100 may be integrated into a single chip.

The display unit 300 may be any device that can output an image. For instance, the display unit 300 may be implemented as a computer, a mobile phone, a smart phone, or any type of image output terminal.

FIG. 2 is a detailed block diagram of an example of a binary pixel 130 in the pixel array 110 illustrated in FIG. 1. Referring to FIGS. 1 and 2, a plurality of binary pixels 130 may be arranged in a matrix to form the pixel array 110. Each of the plurality of binary pixels 130 may include a single transistor SX and a photodiode PD. Although it is assumed that the photodiode PD is used as a photoelectric conversion element for clarity of the description, the scope of the present disclosure is not restricted thereto.

The photodiode PD may have a first end connected to a ground and a second end connected to or electrically separated from the body of the single transistor SX. The photodiode PD may hold photocharges generated in proportion to the intensity of incident light that has passed through the lens 500.

The single transistor SX has a source and a gate, which are connected to the row driver 160 to receive a source signal VS and a gate signal VG, respectively. The binary pixel 130 may have three operation modes, i.e., an integration mode, a reset mode, and a readout mode, according to the source signal VS and the gate signal VG.

In the integration mode, among the photocharges (i.e., electrons and holes) generated by incident light, one type of the photocharges (i.e., electrons or holes) are accumulated in the photodiode PD. In order to induce photocharge amplification using an avalanche effect in the integration mode, the source signal VS, the gate signal VG, and a substrate voltage may be set to a first integration voltage, a second integration voltage, and 0V, respectively. For instance, when the single transistor SX is a P-channel metal oxide semiconductor (PMOS) transistor, the first integration voltage may be 0 V and the second integration voltage may be a power supply voltage (VDD).

In the reset mode, the photocharges accumulated in the photodiode PD are drained through the source or the drain. In the reset mode, the source signal VS, the gate signal VG, and the substrate voltage may be set to a first reset voltage, a second reset voltage, and 0V, respectively. For instance, when the single transistor SX is a PMOS transistor, the first reset voltage may be the VDD and the second reset voltage may be 0 V.

In the readout mode, a binary pixel signal corresponding to the photocharges accumulated in the photodiode PD is output through a column line COL. The binary pixel signal includes an image signal and a reset signal. The image signal is a signal that is output in the readout mode immediately following the integration mode, and the reset signal is a signal that is output in the readout mode immediately following the reset mode. For clarity of the description, the explanation of the readout mode for the reset signal will be omitted.

In the readout mode, the body voltage of the signal transistor SX may be different depending on the photocharges accumulated in the photodiode PD. The threshold voltage (Vth) of the single transistor SX may vary with the body voltage. When the threshold voltage (Vth) of the single transistor SX changes, the same result as that obtained when a source voltage changes can be obtained. In other words, as the threshold voltage (Vth) of the single transistor SX changes, the predetermined gate voltage VG may be higher or lower than the threshold voltage (Vth). Accordingly, the binary pixel signal that is output through the column line COL may have a low or high level.

In the readout mode, the source signal VS, the gate signal VG, and the substrate voltage may be set to a first read voltage, a second read voltage, and 0V, respectively. For instance, if the single transistor SX is a PMOS transistor, the first read voltage may be the VDD, and the second read voltage may be higher than the threshold voltage (Vth) of the single transistor SX that is measured when there is no influence from the photodiode PD.

When the single transistor SX enters the readout mode at the reception of voltage, the change in the threshold voltage (Vth) of the single transistor SX according to the photocharges accumulated at the photodiode PD may be sensed and a drain voltage may be output as a pixel signal. For instance, it is assumed that the single transistor SX is a PMOS transistor, the threshold voltage (Vth) of the single transistor SX that is measured when there is no influence of the photodiode PD is 1 V, and the second read voltage applied to the gate is 1.2 V. It is also assumed that the threshold voltage (Vth) of the single transistor SX changes to 1.4 V when the photodiode PD has been saturated with the photocharges. In other words, when the photodiode PD has been saturated with the photocharges, the single transistor SX may be activated and a binary pixel signal may be output at the high level (e.g., 1 V). Contrarily, when the photodiode PD has not been saturated with the photocharges, the single transistor SX may be deactivated and the binary pixel signal may be output at the low level (e.g., 0 V). That the photodiode PD has been saturated with the photocharges means that the amount of the photocharges accumulated in the photodiode PD is greater than the integration capacity of the photodiode PD. The integration capacity of the photodiode PD may vary with the volume and doping ratio of the photodiode PD. In the embodiments of the present disclosure, it is assumed that the doping ratio of the photodiode PD is fixed and the integration capacity depends only on the volume of the photodiode PD.

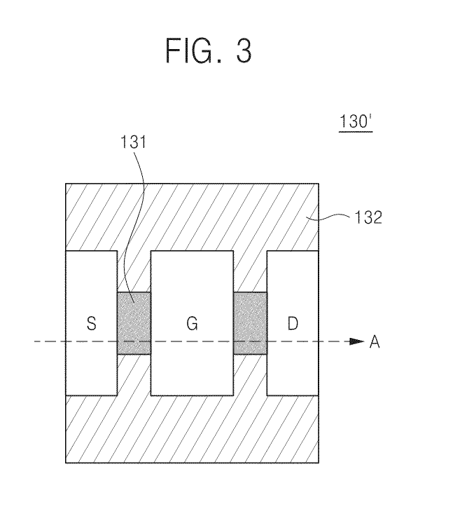

FIG. 3 is a diagram of an example layout 130′ for forming the binary pixel 130 illustrated in FIG. 2. Referring to FIGS. 2 and 3, in the layout 130′, a source S, a gate G and a drain D of the single transistor SX are sequentially formed, and a channel 131 connecting the source S and the drain D is formed. In addition, a well layer 132 for an electrical isolation from adjacent binary pixels (not shown) may be included in the layout 130′. Although not shown, a shallow trench isolation (STI) (not shown) for the electrical isolation from another binary pixel adjacent to the current sub pixel 130 in an A direction or a direction perpendicular to the A direction may be included in the layout 130′.

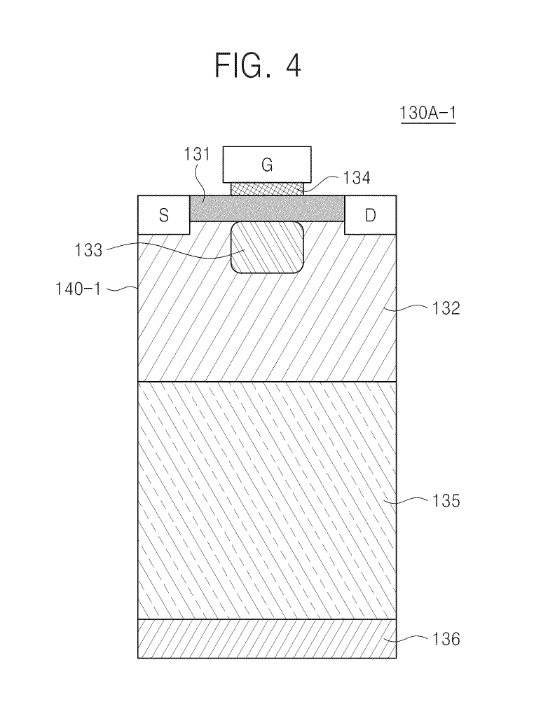

FIG. 4 is a diagram of a cross section 130A-1 of a semiconductor substrate 140-1 taken along the A direction in the layout 130′ illustrated in FIG. 3 according to some embodiments of the present disclosure. Referring to FIGS. 3 and 4, the cross section 130A-1 may include the source S, gate G and drain D of the single transistor SX, the channel 131, the well layer 132, a photodiode 133 (PD in FIG. 2), a gate insulating layer 134, a first epitaxial layer 135, and a second epitaxial layer 136. The semiconductor substrate 140-1 may be formed based on a silicon (Si) substrate.

The source S, gate G and drain D of the single transistor SX may function as the terminals of the single transistor SX. The source S and the drain D may be formed as a high-concentration doped region using ion implantation. When the single transistor SX is a PMOS transistor, the source S and the drain D may be a P region doped with P+ type impurities. Contrarily, when the single transistor is an N-channel metal oxide semiconductor (NMOS) transistor, the source S and the drain D may be an N region doped with N+ type impurities. The gate G may be formed using poly silicon.

The channel 131 may be formed to smooth the flow of carriers between the source S and the drain D of the single transistor SX. The carriers are holes when the single transistor SX is the PMOS transistor. The carriers are electrons when the single transistor SX is the NMOS transistor. The channel 131 is not essential, but it may be selectively formed. The channel 131 may be formed using silicon (Si), germanium (Ge), or silicon-germanium (SiGe).

The well layer 132 may be doped with N− type impurities when the single transistor SX is the PMOS transistor, and it may be doped with P− type impurities when the single transistor SX is the NMOS transistor.

The photodiode 133 may be formed in the well layer 132 using the ion implantation. The photodiode 133 may be doped with N type impurities when the single transistor SX is the PMOS transistor, and it may be doped with P type impurities when the single transistor SX is the NMOS transistor. The depth of the photodiode 133 may be determined according to energy (e.g., 2 to 3 meV) used for the ion implantation. For instance, the greater the energy used for the ion implantation, the deeper the photodiode 133 is formed.

The gate insulating layer 134 may be formed for an insulation between the gate G and the channel 131. The gate insulating layer 134 may be formed using SiO₂, SiON, SiN, Al₂O₃, Si₃N₄, GeₓO_{y}N_{z}, GeₓSi_{y}O_{z}, or a high dielectric constant material. The high dielectric constant material may be formed using atomic layer deposition of HfO₂, ZrO₂, Al₂O₃, Ta₂O₅, hafnium silicate, zirconium silicate, or a combination thereof.

The first epitaxial layer 135 and the second epitaxial layer 136 may be formed using an epitaxial growth method. When the single transistor SX is the PMOS transistor, the first and second epitaxial layers 135 and 136 may be doped with P− type and P+ type impurities, respectively. Contrarily, when the single transistor SX is the NMOS transistor, the first and second epitaxial layers 135 and 136 may be doped with N− type and N+ type impurities, respectively.

Although not shown in FIG. 4, conducting wires for the operation of the pixel array 110, i.e., conducting wires for connection with the row driver 160 and the readout block 190 may be formed on the source S, the gate G, and the drain D to realize back side illumination (BSI) that increases the light guiding efficiency of the photodiode 133.

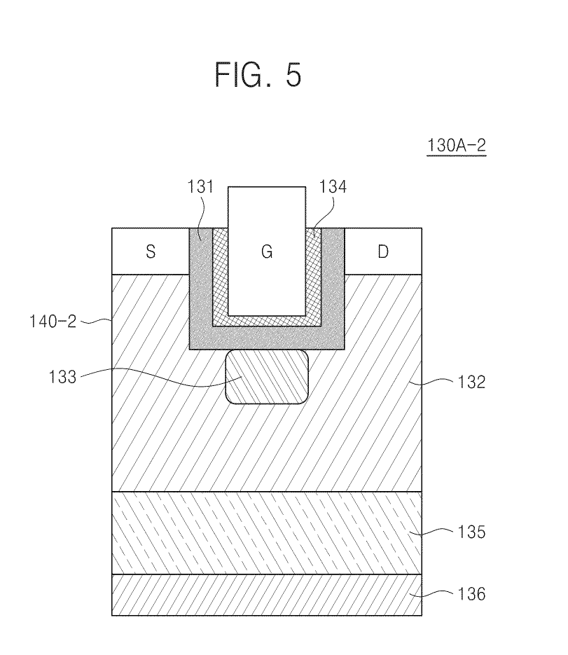

FIG. 5 is a diagram of a cross section 130A-2 of a semiconductor substrate 140-2 taken along the A direction in the layout 130′ illustrated in FIG. 3 according to other embodiments of the present disclosure. Referring to FIGS. 3 through 5, the gate G may be embedded in the semiconductor substrate 140-2 using an etching process in the cross section 130A-2. In other words, the semiconductor substrate 140-2 may have a recess gate structure.

Accordingly, the channel 131 is also embedded in the semiconductor substrate 140-2, so that the photodiode 133 is formed within the semiconductor substrate 140-2. Therefore, the distance from the photodiode 133 to the source S or the drain D increases. When the distance between the photodiode 133 and the source S or the drain D increases, the influence of the photodiode 133 to the channel 131 can be increased.

In particular, in an ultra-small pixel structure in which the length of the gate G is 50 nm or less, the distance from the photodiode 133 to the source S or the drain D is very close, thereby obstructing the smooth operation of the single transistor SX. In other words, when the length of the gate G is 50 nm or less, the distance between the photodiode 133 and the source S or the drain D is so close that the influence of the photodiode 133 to the channel 131 can be decreased. As a result, a pixel signal insensitive to the photocharges accumulated in the photodiode 133 may be generated. Therefore, when the image sensor 100 is implemented using microscopic pixels, the pixel array 110 may be formed in the recess gate structure.

Apart from the above-described differences, the semiconductor substrate 140-2 illustrated in FIG. 5 is substantially the same as the semiconductor substrate 140-1 illustrated in FIG. 4.

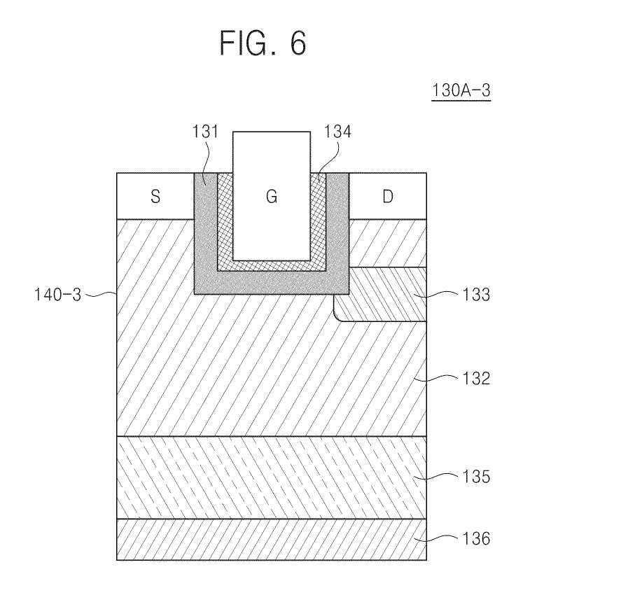

FIG. 6 is a diagram of a cross section 130A-3 of a semiconductor substrate 140-3 taken along the A direction in the layout 130′ illustrated in FIG. 3 according to further embodiments of the present disclosure. Referring to FIGS. 3 through 6, the gate G in the cross section 130A-3 may be formed in the recess gate structure, as in the cross section 130A-2 illustrated in FIG. 5.

The photodiode 133 may be formed closer to the drain D than to the source S around the gate G. In other words, the photodiode 133 may be formed in an asymmetric structure with respect to the gate G. In other embodiments, the photodiode 133 may be formed closer to the source S than to the drain D.

When the photodiode 133 is formed as shown in FIG. 6, the entire size of the photodiode 133 may be decreased. When the entire size of the photodiode 133 decreases, the distance between photocharges accumulated in the photodiode 133 and the channel 131 also decreases, and therefore, the influence of the photodiode 133 to the channel 131 increases according to Coulomb's law.

In particular, the recess gate structure in which the photodiode 133 is formed asymmetrically with respect to the gate G as shown in FIG. 6 in the ultra-small pixel structure having the gate G 32 nm or less in length may have a higher photoelectric conversion gain (mV/e−) and higher resistance change (%/e−) than the simple recess gate structure illustrated in FIG. 5. For instance, in the ultra-small pixel structure in which the length of the gate G is 22 nm, a single photocharge may generate a conversion voltage of about 60 mV and a resistance change of about 18%.

FIG. 7 is a diagram of an example 110′ of a part of the pixel array 110 illustrated in FIG. 1. Referring to FIGS. 1, 2, and 7, a partial pixel array 110′ shows only a part of the pixel array 110 illustrated in FIG. 1 for clarity of the description. Although only the part of the pixel array 110 is described, the description thereof could be applied to the entire pixel array 110.

The partial pixel array 110′ may include binary pixels 130 arrange in a 16×16 matrix. The binary pixels 130 may be divided into first through fourth pixel groups 120-1 through 120-4. The binary pixels 130 are arrange in an 8×8 matrix in the first through fourth pixel groups 120-1 through 120-4. Here, the 16×16 matrix and the 8×8 matrix are just examples, and the number of binary pixels 130 included in the first through fourth pixel groups 120-1 through 120-4 is not limited to this example.

Binary pixel signals that are output from each of the first through fourth pixel groups 120-1 through 120-4 may be calculated into a single pixel value by the ISP 220. In other words, when the first through fourth pixel groups 120-1 through 120-4 are arranged in a Bayer pattern, the binary pixels 130 included in the first pixel group 120-1 may also include a red filter layer below a semiconductor substrate (i.e., below the second epitaxial layer 136). The binary pixels 130 included in the second and third pixel groups 120-2 and 120-3 may also include a green filter layer below the semiconductor substrate, and the binary pixels 130 included in the fourth pixel group 120-4 may also include a blue filter layer below the semiconductor substrate.

Accordingly, the binary pixel signals that are output from the first through fourth pixel groups 120-1 through 120-4 may be converted into an R pixel value, a Ga pixel value, Gb pixel value, and a B pixel value, respectively.

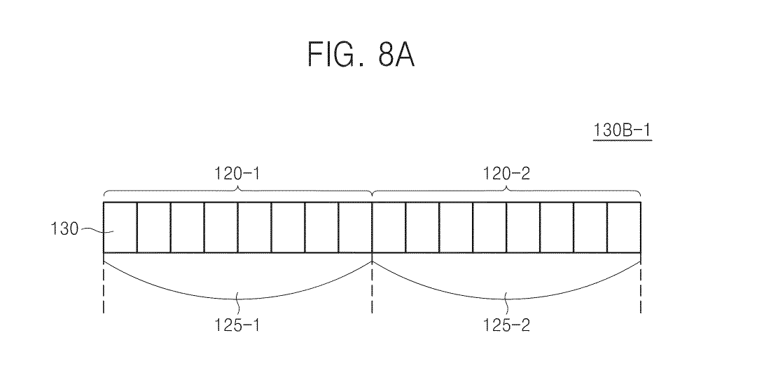

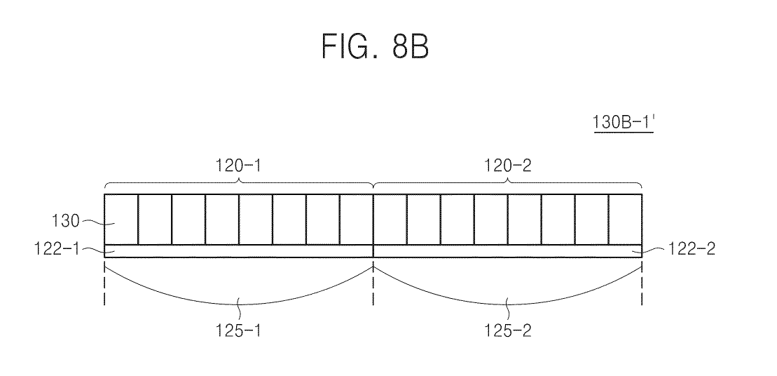

FIG. 8A is a diagram of a cross section 130B-1 of the partial pixel array 110′ illustrated in FIG. 7, taken along a B direction, according to some embodiments of the present disclosure. FIG. 8B is a diagram of a cross section 130B-1′ of the partial pixel array 110′ illustrated in FIG. 7, taken along the B direction, according to other embodiments of the present disclosure.

Referring to FIGS. 1 through 8B, the cross section 130B-1 of the partial pixel array 110′ illustrated in FIG. 7 may include the binary pixels 130 included in the first and second pixel groups 120-1 and 120-2 arranged in the B direction, a first micro lens 125-1, and a second micro lens 125-2. The cross section 130B-1′ of the partial pixel array 110′ may further include a color filter layer 122-1 having an area corresponding to the first pixel group 120-1 between the first micro lens 125-1 and the binary pixels 130 included in the first pixel group 120-1, and a color filter layer 122-2 having an area corresponding to the second pixel group 120-2 between the second micro lens 125-2 and the binary pixels 130 included in the second pixel group 120-2. The color filter layers 122-1 and 122-2 function as a filter that passes light with a predetermined wavelength.

The first micro lens 125-1 may have an area corresponding to the first pixel group 120-1 and may be formed below the binary pixels 130 included in the first pixel group 120-1. The first micro lens 125-1 may refract incident light that has passed through the lens 500 illustrated in FIG. 1 so as to focus the light on binary pixels 130 close to the center of the first pixel group 120-1. Accordingly, as compared with a case when the first micro lens 125-1 is not provided, the binary pixels 130 close to the center of the first pixel group 120-1 absorb more incident light, so that the photodiode 133 of these binary pixels 130 accumulates more photocharges. Contrarily, as compared with a case when the first micro lens 125-1 is not provided, the binary pixels 130 close to the edge of the first pixel group 120-1 absorb less light, so that the photodiode 133 of these binary pixels 130 accumulates less photocharges.

As described with reference to FIG. 2, the pixel signal of each of the binary pixels 130 is a digital signal having the high or low level. The pixel signal may indicate the high or low level depending on whether the threshold voltage (Vth) is at least a predetermined read voltage (i.e., a voltage applied to VG in FIG. 2 in readout mode) or not. The threshold voltage (Vth) changes according to whether the photodiode 133 of each binary pixel 130 has been saturated or not.

It is assumed that each of the binary pixels 130 included in the first pixel group 120-1 includes the photodiode 133 that has the same integration capacity. When the photodiode 133 included in each of the binary pixels 130 in the first pixel group 120-1 has a large integration capacity, no photodiode 133 may be saturated under a condition of low illumination. In this case, every binary pixel 130 in the first pixel group 120-1 outputs a pixel signal at the low level only. Accordingly, even when some of the binary pixels 130 receive more incident light than others under the condition of low illumination, they cannot be distinguished.

When the photodiode 133 included in each of the binary pixels 130 in the first pixel group 120-1 has a small integration capacity, every photodiode 133 may be saturated under a condition of high illumination. In this case, every binary pixel 130 in the first pixel group 120-1 outputs a pixel signal at the high level only. Accordingly, even when some of the binary pixels 130 receive more incident light than others under the condition of high illumination, they cannot be distinguished.

Therefore, the sensitivity of the binary pixels 130 is decreased in the low or high illumination, thereby decreasing the quality of image data. In particular, the binary pixels 130 have a very small area since they include only the single transistor SX without any other transistors, and the photodiode 133 of the binary pixels 130 has an integration capacity which is not large due to a small volume. Therefore, the quality of the image data may be degraded at the high illumination.

However, when the cross sections 130B-1 and 130B-1′ of the partial pixel array 110′ include the first micro lens 125-1 as shown in FIGS. 8A and 8B, the first micro lens 125-1 focuses incident light on the binary pixels 130 close to the center of the first pixel group 120-1. Therefore, the closer to the center of the first pixel group 120-1 the binary pixels 130 are, the more incident light the binary pixels 130 absorb even though the integration capacity of the photodiode 133 is the same throughout the first pixel group 120-1. As a result, the same effect as if the integration capacity of the photodiode 133 of the binary pixels 130 close to the center of the first pixel group 120-1 decreases can be obtained. Contrarily, the closer to the edge of the first pixel group 120-1 the binary pixels 130 are, the less incident light the binary pixels 130 absorb. Therefore, the same effect as if the integration capacity of the photodiode 133 of the binary pixels 130 close to the edge of the first pixel group 120-1 increases can be obtained.

Accordingly, a phenomenon in which no photodiode 133 in the binary pixels 130 is saturated at the low illumination and a phenomenon in which every photodiode 133 in the binary pixels 130 is saturated at the high illumination can be prevented. In other words, the sensitivity of the binary pixels 130 is not decreased at either the low illumination or the high illumination, so that the quality of the image data is increased.

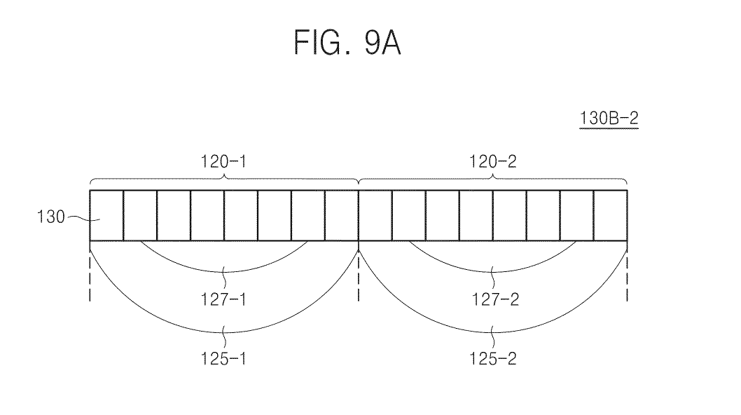

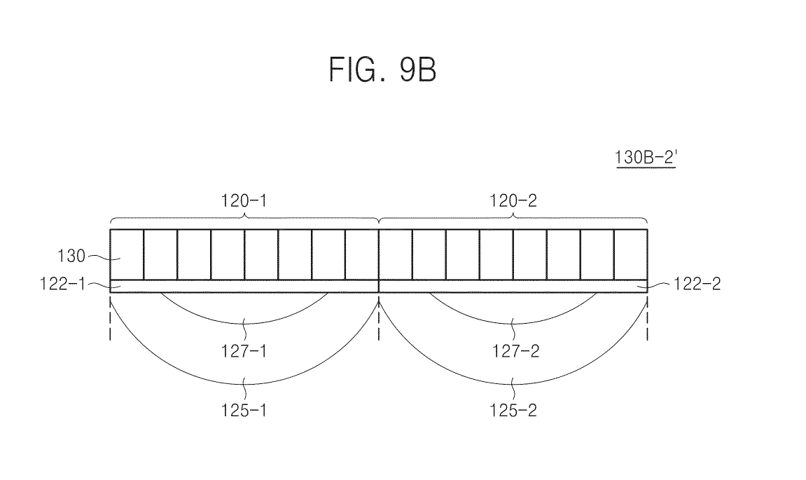

FIG. 9A is a diagram of a cross section 130B-2 of the partial pixel array 110′ illustrated in FIG. 7, taken along the B direction, according to further embodiments of the present disclosure. FIG. 9B is a diagram of a cross section 130B-2′ of the partial pixel array 110′ illustrated in FIG. 7, taken along the B direction, according to other embodiments of the present disclosure.

Referring to FIGS. 1 through 9B, the cross section 130B-2 of the partial pixel array 110′ may further include a first sub micro lens 127-1 and a second sub micro lens 127-2, as compared to the cross section 130B-1′ illustrated in FIG. 8A. The cross section 130B-2′ illustrated in FIG. 9B may further include the color filter layers 122-1 and 122-2 illustrated in FIG. 8B, as compared to the cross section 130B-2 illustrated in FIG. 9A.

The first sub micro lens 127-1 may be formed below the binary pixels 130 close to the center of the first pixel group 120-1. The second sub micro lens 127-2 may be formed below the binary pixels 130 close to the second pixel group 120-2. As shown in FIGS. 9A and 9B, the binary pixels 130 close to the center of the first or second pixel group 120-1 or 120-2 may be arranged in a matrix of four rows and four columns, but the present disclosure is not restricted to this example.

The first sub micro lens 127-1 further refracts the incident light that has passed through the first micro lens 125-1 so as to focus the incident light on the binary pixels 130 closer to the center of the first pixel group 120-1 among the 4×4 binary pixels 130. The second sub micro lens 127-2 further refracts the incident light that has passed through the second micro lens 125-2 so as to focus the incident light on the binary pixels 130 closer to the center of the second pixel group 120-2 among the 4×4 binary pixels 130. In other words, when the first and second sub micro lenses 127-1 and 127-2 are added, the integration capacity of the photodiodes 133 included in the first and second pixel groups 120-1 and 120-2 can be more hierarchically controlled.

The refractive index of the first and second sub micro lenses 127-1 and 127-2 may be greater than that of the first and second micro lenses 125-1 and 125-2 so that the incident light can be focused on the center of each of the first and second pixel groups 120-1 and 120-2 without being reflected. Although only the first sub micro lens 127-1 and the second sub micro lens 127-2 are provided between the first micro lens 125-1 and the binary pixels 130 or between the second micro lens 125-2 and the binary pixels 130 in the embodiments illustrated in FIGS. 9A and 9B, more sub micro lenses may be provided according to the embodiments.

When the micro lenses 125-1, 125-2, 127-1, and 127-2 are provided as shown in FIGS. 8A through 9B, substantially the same effect as if the integration capacity of the photodiodes 133 included in the first and second pixel groups 120-1 and 120-2 is controlled can be obtained without performing an additional process on the binary pixels 130.

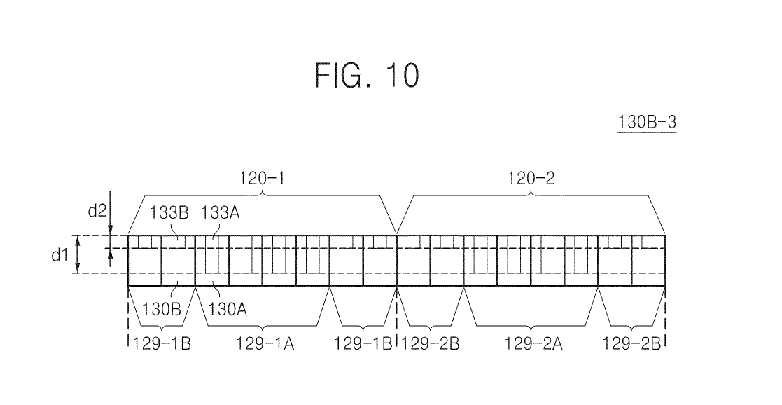

FIG. 10 is a diagram of a cross section 130B-3 of the partial pixel array 110′ illustrated in FIG. 7, taken along the B direction, according to still other embodiments of the present disclosure. Referring to FIGS. 1 through 10, the cross section 130B-3 of the partial pixel array 110′ includes the first pixel group 120-1 and the second pixel group 120-2. The first pixel group 120-1 includes a first binary pixel group 129-1A and a second binary pixel group 129-1B. The second pixel group 120-2 includes a first binary pixel group 129-2A and a second binary pixel group 129-2B. Each of the first binary pixel groups 129-1A and 129-2A may include the binary pixels 130 arranged in a matrix of four rows and four columns close to the center of the first or second pixel group 120-1 or 120-2. Each of the second binary pixel groups 129-1B and 129-2B may include the binary pixels 130 close to the edge of the first or second pixel group 120-1 or 120-2, excluding the binary pixels 130 included in the first binary pixel groups 129-1A and 129-2A. The size, the number and the arrangement of the binary pixels 130A and 130B that are included in the first binary pixel groups 129-1A and 129-2A and the second binary pixel groups 129-1B and 129-2B respectively included in the first and second pixel groups 120-1 and 120-2 are not restricted to the embodiments illustrated in FIG. 10. Moreover, at least one more binary pixel group having a different pixel depth may be provided in addition to the first binary pixel groups 129-1A and 129-2A and the second binary pixel groups 129-1B and 129-2B.

A photodiode 133A of each of the binary pixels 130A included in the first binary pixel groups 129-1A and 129-2A may be formed more deeply than a photodiode 133B of each of the binary pixels 130B included in the second binary pixel groups 129-1B and 129-2B. For instance, the photodiode 133A may be formed to have a first depth d1 while the photodiode 133B may be formed to have a second depth d2. The first depth d1 may be greater than the second depth d2.

Accordingly, the volume of the photodiode 133A in the first binary pixel groups 129-1A and 129-2A is greater than that of the photodiode 133B in the second binary pixel groups 129-1B and 129-2B, and therefore, the photodiode 133A in the first binary pixel groups 129-1A and 129-2A may have a larger integration capacity than the photodiode 133B in the second binary pixel groups 129-1B and 129-2B. As a result, a phenomenon in which no photodiode 133 in the binary pixels 130 is saturated at the low illumination, and a phenomenon in which every photodiode 133 in the binary pixels 130 is saturated at the high illumination can be prevented. In other words, the sensitivity of the binary pixels 130 is not decreased at either the low illumination or the high illumination, so that the quality of the image data is increased.

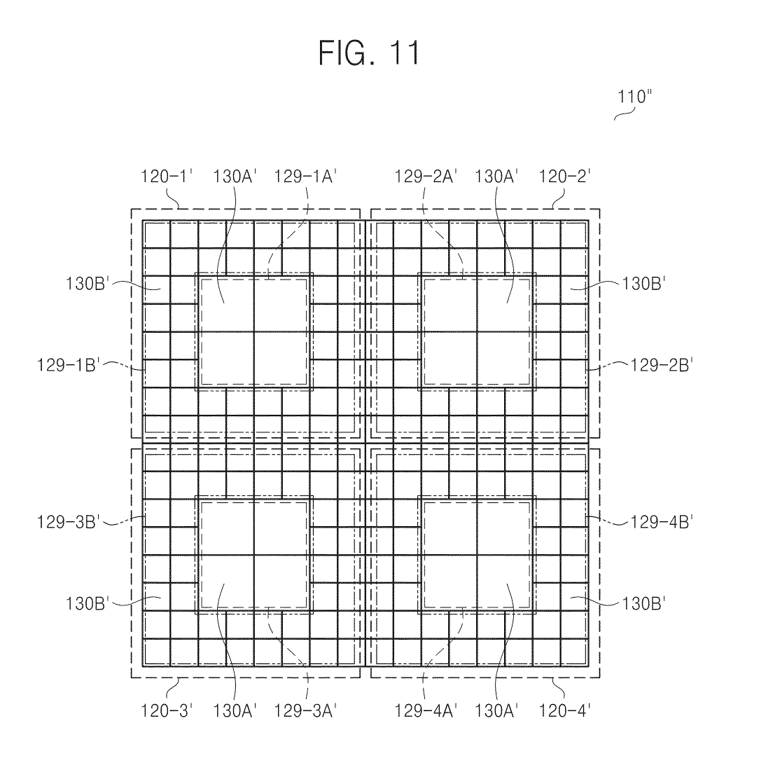

FIG. 11 is a diagram of another example 110″ of the part of the pixel array 110 illustrated in FIG. 1. Referring to FIGS. 1 through 11, unlike the partial pixel array 110′ illustrated in FIG. 7 but similar to the embodiments illustrated in FIG. 10, the partial pixel array 110″ includes first through fourth pixel groups 120-1′ through 120-4′ which include first binary pixel groups 129-1A′, 129-2A′, 129-3A′, and 129-4A′, respectively, and second binary pixel groups 129-1B′, 129-2B′, 129-3B′, and 129-4B′, respectively. The size, the number and the arrangement of the binary pixels 130A′ and 130B′ included in the first binary pixel groups 129-1A′, 129-2A′, 129-3A′, and 129-4A′ and the second binary pixel groups 129-1B′, 129-2B′, 129-3B′, and 129-4B′ in the first through fourth pixel groups 120-1′ through 120-4′ are not restricted to the example shown in FIG. 11. At least one more binary pixel group having a different pixel area may be provided in addition to the first binary pixel groups 129-1A′, 129-2A′, 129-3A′, and 129-4A′ and the second binary pixel groups 129-1B′, 129-2B′, 129-3B′, and 129-4B′.

The binary pixels 130A′ included in the first binary pixel groups 129-1A′, 129-2A′, 129-3A′, and 129-4A′ may have a larger area than the binary pixels 130B′ included in the second binary pixel groups 129-1B′, 129-2B′, 129-3B′, and 129-4B′. For instance, each of the binary pixels 130A′ may have an area corresponding to four binary pixels 130B′. Accordingly, a photodiode (not shown) included in each binary pixel 130A′ may have a larger volume and a greater integration capacity than a photodiode (not shown) included in each binary pixel 130B′.

As a result, a phenomenon in which no photodiode in the binary pixels 130A′ and 130B′ is saturated at the low illumination, and a phenomenon in which every photodiode in the binary pixels 130A′ and 130B′ is saturated at the high illumination can be prevented. In other words, the sensitivity of the binary pixels 130A′ and 130B′ is not decreased at either the low illumination or the high illumination, so that the quality of the image data is increased.

The micro lenses 125-1 and 125-2 illustrated in FIGS. 8A and 8B, the sub micro lenses 127-1 and 127-2 illustrated in FIGS. 9A and 9B, the photodiodes 133A and 133B formed to have different depths d1 and d2 in FIG. 10, and the photodiodes formed to have different areas in FIG. 11 may be combined with one another without being mutually exclusive. For instance, when the micro lenses 125-1 and 125-2 illustrated in FIGS. 8A and 8B are formed below binary pixels, each of the binary pixels may include the photodiode 133A or 133B having a different depth in a different group as shown in FIG. 10.

In addition, the ISP 220 may pixelize each pixel group using an operation such as applying a predetermined weight to each pixel signal received from the readout block 190 and adding the weighted pixel signals together. The ISP 220 may generate the image data based on pixelized pixel signals. For instance, the ISP 220 may apply a higher weight to a pixel signal of a binary pixel 130 closer to the center of the first pixel group 120-1 shown in FIGS. 8A and 8B (e.g., the ISP 220 may divide the first pixel group 120-1 into at least two binary pixel groups and may apply a weight to a binary pixel 130 according to the area and position of a binary pixel group in which the binary pixel 130 is included) or may apply a lower weight to a pixel signal of the second binary pixel group 129-1B illustrated in FIG. 10 than to a pixel signal of the first binary pixel group 129-1A.

For instance, it is assumed that 64 binary pixels 130 included in the first pixel group 120-1 illustrated in FIG. 7 are divided into a first binary pixel group close to the center of the first pixel group 120-1 and a second binary pixel group close to the edge of the first pixel group 120-1. It is also assumed that each of the first and second binary pixel groups includes 32 binary pixels 130, and the first pixel group 120-1 is formed below a red filter to correspond to an R pixel. It is assumed that 20 binary pixels in the first binary pixel group and 10 binary pixels in the second binary pixel group output pixel signals at the high level in a single frame.

In this case, during the pixelization by the ISP 220, color intensity of the R pixel in the first pixel group 120-1 may be obtained using Equation 1:

$$R {pixel}^{′} s color intensity = - {N}^{2} {log}_{2} ( 1 - ( \frac{aN {1}_{ON}}{N 1 + N 2} + \frac{bN {2}_{ON}}{N 1 + N 2} ) ) \qquad ( 1 )$$

where N is the number of binary pixels included in a row or column of the first pixel group 120-1, N1 is the number of binary pixels included in the first binary pixel group, N1_{ON} is the number of binary pixels outputting a pixel signal at the high level among the binary pixels included in the first binary pixel group, N2 is the number of binary pixels included in the second binary pixel group, N2_{ON} is the number of binary pixels outputting a pixel signal at the high level among the binary pixels included in the second binary pixel group, and “a” and “b” respectively denote a first weight and a second weight which depend on a characteristic difference between the first binary pixel group and the second binary pixel group. For instance, the characteristic difference may increase when the refractive index of the micro lenses 125-1 and 125-2 illustrated in FIGS. 8A and 8B increases, when the refractive index of the micro lenses 125-1 and 125-2 and the sub micro lenses 127-1 and 127-2 illustrated in FIGS. 9A and 9B increases, when the depth difference (i.e., d1−d2) between the photodiodes 133A and 133B illustrated in FIG. 10 increases, or when the area difference between the binary pixels 130A′ and 130B′ illustrated in FIG. 11 increases. The difference between the first weight and the second weight may be controlled to increase according to the characteristic difference.

For instance, it is assumed that a=1/(1+2) and b=2/(1+2). In this case, the color intensity of the R pixel in the first pixel group 120-1 is −82 log₂(1−((1/3)*20/(32+32)+(2/3)*10/(32+32)) which is about 6.4933.

Here, the first weight, the second weight, and Equation 1 determining the color intensity of each pixel are just examples. In other embodiments, a pixel group may be divided into at least three binary pixel groups when the color intensity of each pixel is determined.

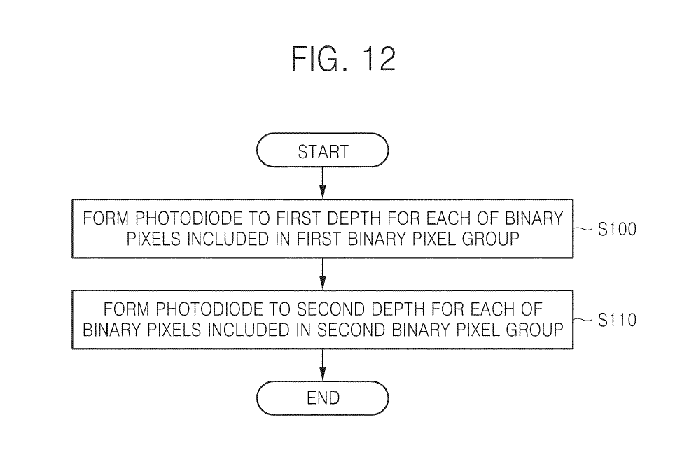

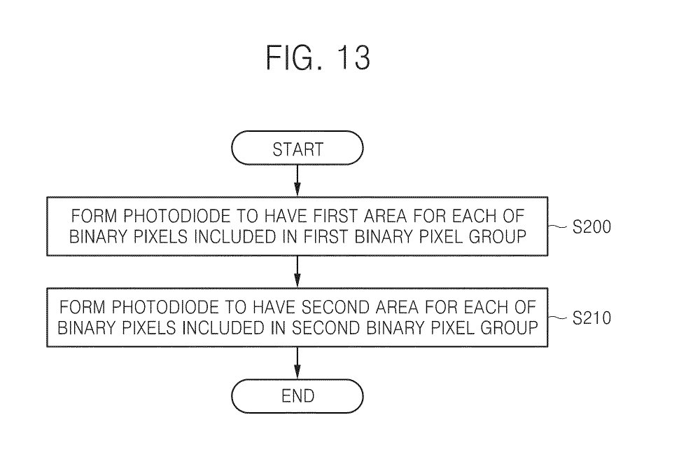

FIG. 12 is a flowchart of an example method of forming a photodiode for each of the binary pixels 130A and 130B illustrated in FIG. 10. FIG. 13 is a flowchart of an example method of forming a photodiode for each of the binary pixels 130A′ and 130B′ illustrated in FIG. 11.

Referring to FIGS. 10 through 13, when the pixel array 110 is manufactured, the photodiode 133A of each of the binary pixels 130A included in the first binary pixel groups 129-1A and 129-2A may be formed to have the first depth d1 by performing ion implantation using a first energy in operation S100. When the pixel array 110 is manufactured, the photodiode 133B of each of the binary pixels 130B included in the second binary pixel groups 129-1B and 129-B may be formed to have the second depth d2 by performing the ion implantation using a second energy in operation S110. The first energy may be greater than the second energy, and the first depth d1 may be greater than the second depth d2.

When the pixel array 110 is manufactured, the photodiode of each of the binary pixels 130A′ included in the first binary pixel groups 129-1A′, 129-2A′, 129-3A′, and 129-4A′ may be formed to have a first area in a stage of forming a layout in operation S200. When the pixel array 110 is manufactured, the photodiode of each of the binary pixels 130B′ included in the second binary pixel groups 129-1B′, 129-2B′, 129-3B′, and 129-4B′ may be formed to have a second area in a stage of forming the layout in operation S210. The first area may be larger than the second area.

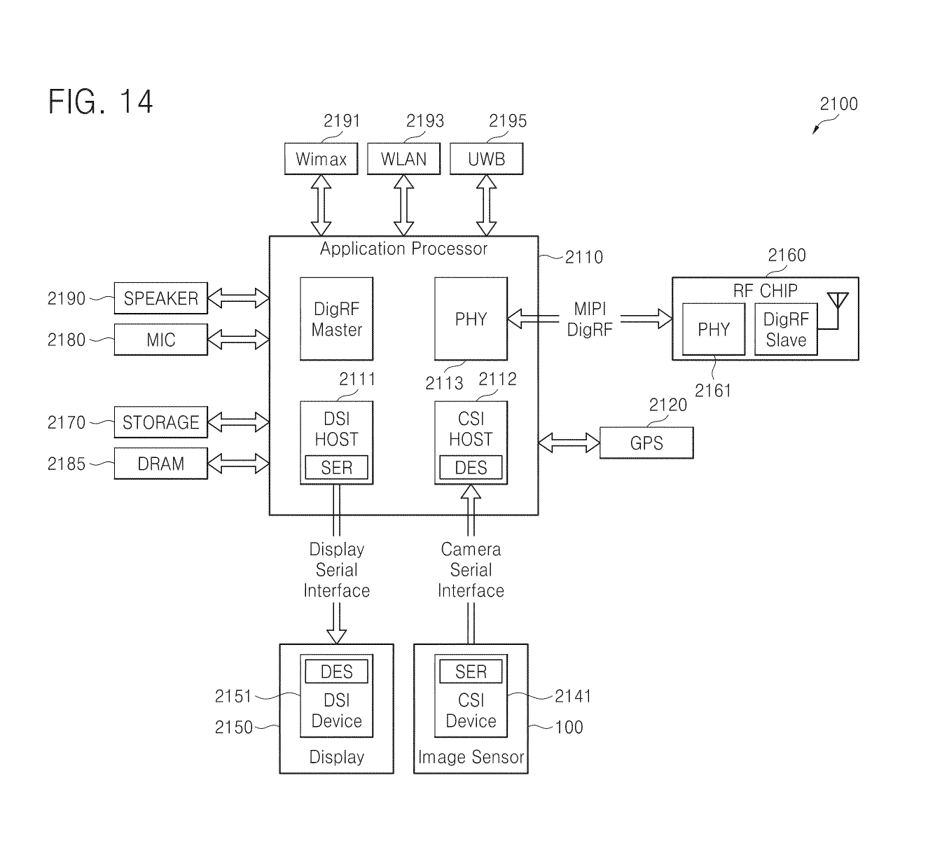

FIG. 14 is a block diagram of an electronic system including an image sensor illustrated in FIG. 1 according to some embodiments of the present disclosure. Referring to FIGS. 1 and 14, the electronic system 2100 may be implemented by a data processing apparatus, such as a mobile phone, a personal digital assistant (PDA), a portable media player (PMP), an internet protocol television (IP TV), or a smart phone that can use or support a mobile industry processor interface (MIPI).

The electronic system 2100 includes the image sensor 100, an application processor 2110 and a display 2150.

A camera serial interface (CSI) host 2112 included in the application processor 2110 performs serial communication with a CSI device 2141 included in the image sensor 100 through CSI. For example, an optical de-serializer (DES) may be implemented in the CSI host 2112, and an optical serializer (SER) may be implemented in the CSI device 2141.

A display serial interface (DSI) host 2111 included in the application processor 2110 performs serial communication with a DSI device 2151 included in the display 2150 through DSI. For example, an optical serializer may be implemented in the DSI host 2111, and an optical de-serializer may be implemented in the DSI device 2151.

The electronic system 2100 may also include a radio frequency (RF) chip 2160 which communicates with the application processor 2110. A physical layer (PHY) 2113 of the electronic system 2100 and a physical layer (PHY) 2161 of the RF chip 2160 communicate data with each other according to a MIPI DigRF standard. The electronic system 2100 may further include at least one element among a GPS 2120, a storage device 2170, a microphone 2180, a DRAM 2185 and a speaker 2190. The electronic system 2100 may communicate using Wimax (World Interoperability for Microwave Access) 2191, WLAN (Wireless LAN) 2193 or UWB (Ultra Wideband) 2195, etc.

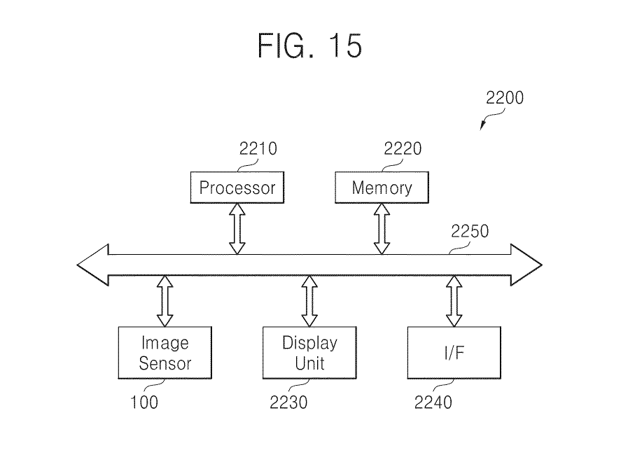

FIG. 15 is a block diagram of an electronic system including an image sensor illustrated in FIG. 1 according to other embodiments of the present disclosure. Referring to FIGS. 1 and 15, the electronic system 2200 includes the image sensor 100, a processor 2210, a memory 2220, a display unit 2230 and an interface 2240.

The processor 2210 may control the operation of the image sensor 100. For example, the processor 2210 may process pixel signals that are output from the image sensor 100, and generate image data.

The memory 2220 may store program for controlling the image sensor 100 and the image data generated by the processor 2210. The processor 2210 may execute the program stored in the memory 2220. For example, the memory 2220 may be implemented by a volatile or non-volatile memory.

The display unit 2230 may display the image data that are output from the processor 2210 or the memory 2220. For example, the display unit 2230 may be a liquid crystal display (LCD), a light emitting diode (LED) display, an organic LED (OLED) display, an active matrix organic light emitting diodes (AMOLED) display or a flexible display.

The interface 2240 may be implemented as an interface for inputting and outputting the image data. For example, the interface 2240 may be implemented by a wireless interface.

The present disclosure can also be embodied as computer-readable codes on a computer-readable medium. The computer-readable recording medium is any data storage device that can store data as a program read by a computer system. Examples of the computer-readable recording medium include read-only memory (ROM), random-access memory (RAM), CD-ROMs, magnetic tapes, floppy disks, and optical data storage devices.

The computer-readable recording medium can also be distributed over network coupled computer systems so that the computer-readable code is stored and executed in a distributed fashion. Also, functional programs, codes, and code segments to accomplish the present disclosure can be easily construed by programmers.

As described above, according to some embodiments of the present disclosure, the sensitivity of binary pixels in an image sensor and an image processing system including the same does not decrease at either low or high illumination, so that the quality of the image data is increased.

While the present disclosure has been particularly shown and described with reference to exemplary embodiments thereof, it will be understood by those of ordinary skill in the art that various changes in forms and details may be made therein without departing from the spirit and scope of the present disclosure as defined by the following claims.

What is claimed is:

1. An image sensor comprising:
a pixel array including a plurality of pixel groups, each of the plurality of pixel groups including a plurality of binary pixels; and
a plurality of micro lenses, each of the plurality of micro lenses being formed below a respective pixel group among the plurality of pixel groups and having an area corresponding to the respective pixel group.

2. The image sensor of claim 1, further comprising a plurality of sub micro lenses, each of the plurality of sub micro lenses being formed between the corresponding micro lens and the corresponding pixel group.

3. The image sensor of claim 2, wherein each of the plurality of sub micro lenses has a greater refractive index than the corresponding micro lens.

4. The image sensor of claim 1, wherein each of the plurality pixel groups comprises a first binary pixel group and a second binary pixel group, a center of the pixel group being closer to the first binary pixel group than to the second binary pixel group, an edge of the pixel group being closer to the second binary pixel group than to the first binary pixel group, and
a photodiode of each binary pixel included in the first binary pixel group has a greater integration capacity than a photodiode of each binary pixel included in the second binary pixel group.

5. The image sensor of claim 4, wherein the photodiode of each binary pixel included in the first binary pixel group is formed deeper than the photodiode of each binary pixel included in the second binary pixel group.

6. The image sensor of claim 4, wherein the photodiode of each binary pixel included in the first binary pixel group is formed larger than the photodiode of each binary pixel included in the second binary pixel group.

7. The image sensor of claim 1, further comprising:
a readout block configured to process a pixel signal that is output from each of columns in the pixel array;
a row driver block configured to control an operation of the pixel array; and
a timing controller configured to control the readout block and the row driver block.

8. The image sensor of claim 7, further comprising an image signal processor configured to pixelize the pixel signal by applying a weight to the pixel signal and generate image data based on the pixelized pixel signal.

9. An image sensor comprising:
a pixel array including a plurality of pixel groups, each of the plurality of pixel groups including a plurality of binary pixels;
a plurality of micro lenses, each of the plurality of micro lenses being formed below a respective pixel group among the plurality of pixel groups and having an area corresponding to the respective pixel group;
a readout block configured to generate a digital pixel signal;
a controller configured to generate a plurality of control signals for controlling operations of the pixel array and the readout block,
wherein each of the plurality of pixel groups comprises a first binary pixel group and a second binary pixel group, a center of the pixel group being closer to the first binary pixel group than to the second binary pixel group, an edge of the pixel group being closer to the second binary pixel group than to the first binary pixel group, and
a photodiode of each binary pixel included in the first binary pixel group has a greater integration capacity than a photodiode of each binary pixel included in the second binary pixel group.

10. The image sensor of claim 9, further comprising a plurality of sub micro lenses, each of the plurality of sub micro lenses being formed between the corresponding micro lens and the corresponding pixel group.

11. The image sensor of claim 9, wherein the controller includes a row driver configured to drive the pixel array in row units, a column driver configured to control an operation of the readout block, a timing generator configured to control operations or timing of the row driver and the column driver, and a control register block configured to store the plurality of control signals.

12. The image sensor of claim 9, wherein the pixel array senses light using a plurality of photoelectric conversion elements, and converts the light into electrical signals to generate binary pixel signals.

13. The image sensor of claim 12, wherein the readout block includes a comparator configured to compare the binary pixel signals with a reference voltage.

14. The image sensor of claim 13, wherein the readout block includes a counter configured to count a comparison result of the comparator, and a memory configured to store a counting result of the counter.

15. A portable electronic device comprising:
an application processor configured to generate image data;
a display configured to display the image data;
a memory configured to store the image data; and
an image sensor configured to generate a pixel signal based on an intensity of incident light, the image sensor including:
a pixel array including a plurality of pixel groups, each of the plurality of pixel groups including a plurality of binary pixels;
a plurality of micro lenses, each of the plurality of micro lenses being formed below a respective pixel group among the plurality of pixel groups and having an area corresponding to the respective pixel group;
a readout block configured to process the pixel signal that is output from each of columns in the pixel array; and
a controller configured to generate a plurality of control signals for controlling operations of the pixel array and the readout block.

16. The portable electronic device of claim 15, wherein the image sensor includes a plurality of sub micro lenses, each of the plurality of sub micro lenses being formed between the corresponding micro lens and the corresponding pixel group.

17. The portable electronic device of claim 15, wherein the image sensor includes a camera serial interface (CSI).

18. The portable electronic device of claim 15, wherein the application processor is configured to pixelize the pixel signal by applying a weight to the pixel signal, and generate the image data based on the pixelized pixel signal.

19. The portable electronic device of claim 15, wherein each of the plurality of binary pixels includes a single transistor and a photoelectric conversion element.

20. The portable electronic device of claim 15, wherein the application processor includes an image signal processor configured to process the pixel signal into the image data.
